(19) United States
(12) Patent Application Publication
(10) Pub. No.: US 2002/0136298 A1
(43) Pub. Date: Sep. 26, 2002

(54) System and method for adaptive streaming of predictive coded video data

(76) Inventors: Chandrashekhara Anantharamu, Singapore (SG); Devagnana Manoranjan, Singapore (SG)

Correspondence Address: Lisa E. Marks, Morrison & Foerster LLP, Suite 5500, 2000 Pensylvania Avenue, N.W., Washington, DC, 20006-1888, US

(21) Appl. No.: 09/761,770

(22) Filed: Jan. 18, 2001

(51) Int. Cl. H04N 7/12

(52) U.S. Cl. 375/240.12; 375/240.01; 348/390.1; 348/384.1

(57) ABSTRACT

This invention provides an adaptive transcoder which streams predictive coded video data over variable bandwidth networks and to devices having varying processing capabilities. The invention dynamically and continuously determines an available network bandwidth and a client device's processing capabilities. This invention uses bit stream transcoding of video data to reduce the bandwidth required to stream the video. Certain frames of a bit stream are replaced with Pseudo-P frames according to the results of rate control feedback and frame ranking. The invention thus transmits a single MPEG stream to multiple devices having varying capabilities and does not add redundancy into the network.

### FIELD OF THE INVENTION

This invention relates generally to streaming of video data and, more specifically, to adaptive streaming of video in variable bandwidth networks and to devices of varying capabilities.

### BACKGROUND OF THE INVENTION

Conventional methods for streaming video send a static, i.e., constant bit-rate stream of video data to all devices connected to a network. Such methods fail to adjust the bit-rate to the needs of a receiving device, i.e., a client, or the network. When a video stream is sent to a client device at too high a bit-rate, the network may become congested and, as a result, drop packets. Or, the client may not have sufficient processing power to decode all the frames that are sent to it and therefore, it may drop some of the frames, which results in distortion of the display. The distortion may be in the form of, for example, pauses or gaps in the display. Therefore, it may not be possible to send a bit stream at one particular rate to all devices connected to a network since different devices have different processing capabilities and different bandwidths available to them. Nor is it is efficient to send a static bit-rate stream to all devices connected to a network. Sending a static bit-rate stream to all devices connected to a network would require that the bit-rate of the stream accord with the network capabilities of the device having access to the lowest bandwidth. Thus, devices that have a higher bandwidth available to them may receive a lower bit-rate stream, which is of a lower quality than a higher bit-rate stream, even though such devices could receive higher bit-rate streams. To overcome the problems associated with sending a static bit-rate stream to devices operating according to varying network capabilities, conventional methods for streaming video store an encoded stream at multiple bit-rates and send an appropriate stream to requesting client devices. This conventional manner of video streaming is illustrated in FIGS. 1A and 1B. Creating such redundancy is time consuming, complex, and costly.

FIG. 1A depicts a conventional method for streaming a pre-coded video stream to multiple clients that may operate according to different bandwidth capabilities. The video stream is pre-encoded into multiple streams, each at a predefined and fixed bit-rate, and stored on a server. Each client requests a video stream at a bit-rate that is suitable for its bandwidth and the server sends an appropriate stream at one of the stored bit-rates to the client. FIG. 1B depicts a conventional method for transmitting a live stream of video data to multiple clients. The video stream is simultaneously passed through multiple encoders, and each of the encoders is dedicated to processing a stream at a particular bit-rate. The set of encoders thus reflects a range of fixed, discrete bit-rates. Each encoder encodes the stream at its predefined bit-rate and transmits the stream to a server. As with coded video, the server streams multiple bit-rate copies of the stream and sends the appropriate stream to the client at a bit-rate indicated by the client.

An additional problem associated with static bit-rate streams arises in dynamic allocation bandwidth networks in which the bandwidth varies throughout the network. In dynamic allocation bandwidth networks, the available bandwidth varies according to, for example, the amount of traffic on the network at a particular time. For instance, if the bandwidth of a network is 56 kbps, the available bandwidth for the client will vary dynamically according to the traffic on the network path from the client to the server. If there is less traffic, the client can access more bandwidth and vice versa. Thus the client is likely to experience bandwidth fluctuations. In such a network, a constant bit-rate video stream is unable to change its transmission rate to match that of the network. Rather, it continues to transmit at a static bit-rate, failing to take advantage of more bandwidth when available and, more importantly, causing breaks and distortion in a video display when the available bandwidth falls below a required bandwidth. To deal with networks where the bandwidth varies dynamically, conventional methods for video streaming encode a video stream by either reducing the frame resolution and/or degrading the quality of a frame. Other conventional methods deal with dynamic bandwidth allocation problems by dropping specific packets of data. Dropping specific packets to accommodate a changing bandwidth does not work for streaming methods that are not error resilient, such as MPEG. In non-error resilient streaming methods, a client cannot decode a bit stream from which packets have been dropped.

Accordingly, a need exists for a more efficient manner of streaming both pre-coded and live video in dynamic bandwidth networks and to devices having various processing capabilities. This manner of streaming should also accord with the capabilities of non-error resilient streaming methods, such as MPEG.

### SUMMARY OF THE INVENTION

This invention provides a system and a method to adaptively transcode predictive coded video data and associated audio data such that the data may be transmitted at a bit-rate that matches an available bandwidth of a network and a client. The term “transcode,” as used in this document, refers to transforming and coding a data stream. Predictive coded video data refers to a stream of video data including multiple frames that have been encoded at a specific bit rate. This system and method can be used to transmit video according to a variety of streaming techniques, including, for example, MPEG.

In accordance with an embodiment of the invention, a method for transmitting predictive coded video data to a client is provided. The method includes receiving a video data stream including predictive coded video data, analyzing the video data stream to determine characteristics of the stream, determining an available bandwidth for transmission of the video data stream to a particular client, determining, according to the characteristics of the video data stream and the available network bandwidth, a coded frame of the video data stream that can be replaced with a replicating frame that replicates a previously decoded frame, i.e., a frame that has already been decoded, replacing the coded frame with the replicating frame to produce a modified video data stream, and transmitting the modified video data stream to the client.

In accordance with another embodiment of the invention, a method for transmitting an audio/video data stream to a client is provided. The method includes receiving an audio/video data stream, analyzing the audio/video data stream to determine characteristics of the stream, separating the audio/video data into an audio data stream and a video data stream, determining an available bandwidth for transmission of the video data stream to a particular client, determining, according to the characteristics of the video data stream and the available network bandwidth, a coded frame of the stream that can be replaced with a replicating frame that replicates a previously decoded frame, replacing the coded frame with the replicating frame to produce a modified video data stream, and transmitting the modified video data stream and the audio data stream to the client.

In accordance with another embodiment of the invention, a method for adaptive transcoding of video data is provided. The method includes receiving a stream of video data, determining in real-time an available bandwidth to a particular client, and creating a modified stream of video data by replacing a frame with a previously encoded frame which replicates a previously decoded frame.

In accordance with yet another embodiment of the invention, a system to transcode predictive coded video data is provided. The system includes a client that receives a modified stream of video data, a content analysis and description system that analyzes the stream of video data to determine characteristics of the stream, a frame ranker subsystem that assigns a numerical rank to each frame included in the stream of video data, a rate control subsystem that determines an available bandwidth of a network and of the client for transmitting the stream of video data to the client, and a transcoder subsystem that modifies the stream of video data to accord with the available bandwidth by replacing a frame with a previously encoded frame which replicates a previous decoded frame according to a frame rank.

In accordance with still another aspect of the invention, a method for adaptive streaming of predictive coded video data that includes a sequence of frames is provided. The method includes receiving a stream of video data, analyzing the stream to determine characteristics of the stream, determining an available bandwidth for transmission of the stream, coding the video data by determining, according to the characteristics of the stream and the available network bandwidth for a particular client, a frame that can be replaced with a frame that replicates the previous decoded frame and replacing the frame with the frame that replicates the previous decoded frame to produce a modified stream, and transmitting the stream to the particular client.

### BRIEF DESCRIPTION OF THE DRAWINGS

FIG. 1A depicts a conventional method for streaming a pre-coded video stream to multiple clients that may have different bandwidth capabilities.

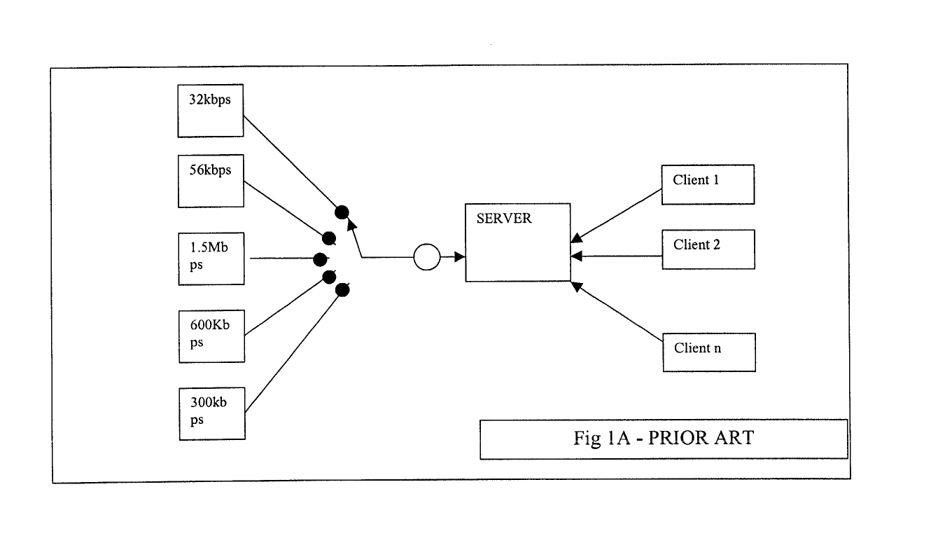

FIG. 1B depicts a conventional method for streaming a live stream of video data to multiple clients.

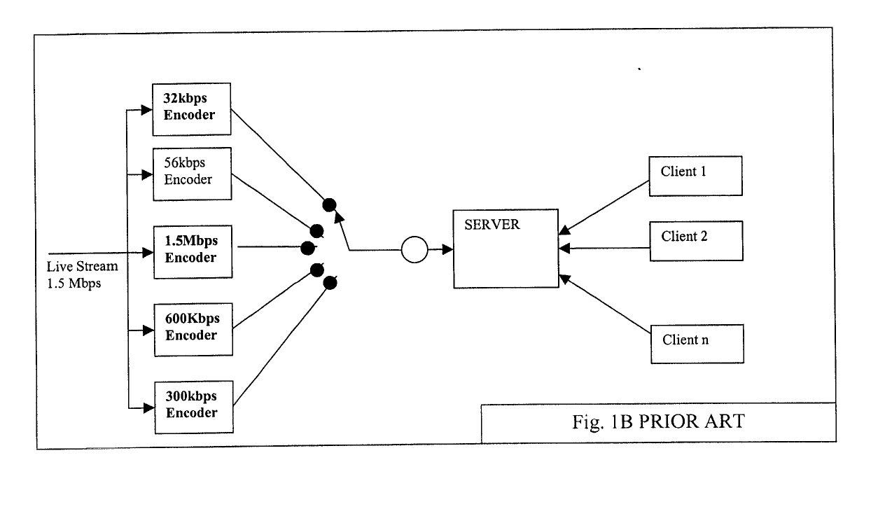

FIG. 2 depicts an illustrative overview block diagram of a presently preferred embodiment of the invention.

FIG. 3 depicts an illustrative block diagram of a more detailed view of an embodiment of this invention.

FIG. 4 depicts an illustrative structure of a Pseudo-P frame.

### DETAILED DESCRIPTION OF THE INVENTION

The following description is presented to enable any person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art would realize that the invention may be practiced without the use of these specific details. In other instances, well-known structures and devices are shown in block diagram form in order not to obscure the description of the invention with unnecessary detail. Thus, this invention is not intended to be limited to the embodiment shown, but is to be accorded the widest scope consistent with the principles and features disclosed herein.

A current embodiment of the invention provides an adaptive analysis and transcoding system (“adaptive transcoder”) which streams video over variable bandwidth networks and to devices having varying processing capabilities. The invention dynamically and continuously determines a client's available network bandwidth and transmits a single MPEG stream, altering it to meet the needs of various client devices without adding redundancy into a network. Rather, it uses frame rate manipulation and rate control mechanisms to transmit the stream to multiple devices on the network. Therefore, the system within which the invention operates does not require multiple encoders to stream live video and does not require pre-coding and storage of a data stream at various bit-rates for on demand video. The term “transcode,” as used in this document, refers to transforming and coding a data stream.

In particular, this invention uses bit stream transcoding of video and audio data to adapt the bandwidth required to transfer a data stream. The frame rate manipulation and rate control subsystems determine which frames can be replaced by a frame that replicates a previous decoded frame to decrease the bit-rate of a stream. Thus, for example, in an MPEG-1 stream certain frames are replaced with Pseudo-P frames, which replicate a previous decoded frame. To further lower the bandwidth requirement, the audio portion of a signal can be also transcoded. In particular, the audio portion of the stream can be re-encoded into a lower bit-rate stream by, for example, reducing the sampling rate of the audio signal, using a coarser quantization, using stereo to mono conversion, or a combination of these and other methods. According to any of these methods, re-encoding the audio portion of the stream into a lower bit-rate may include, for example, decoding the stream, sampling the bit-rate of the decoded stream, and encoding the stream.

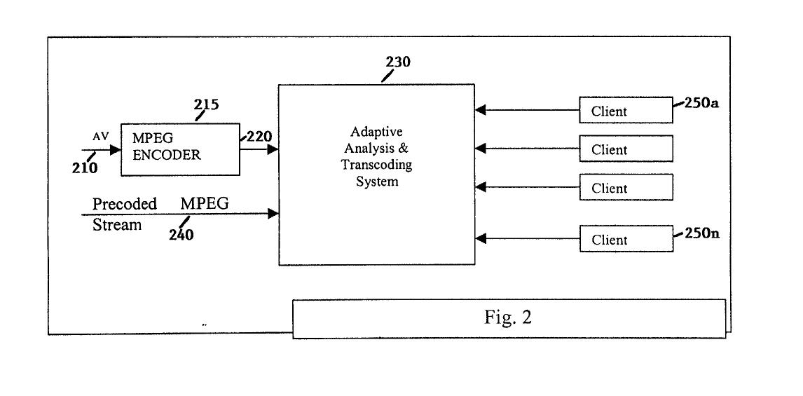

FIG. 2 depicts an illustrative overview block diagram of a present embodiment of the invention. As depicted in FIG. 2, a live audio/video data stream 210 is sent to a MPEG encoder 215 which encodes the stream. The MPEG encoder 215 sends the encoded stream 220 to an adaptive transcoder 230 of the invention. Alternatively, a precoded MPEG stream 240, such as a previously stored stream, is sent directly to the adaptive transcoder 230. Client devices 250a . . . 250n indicate to the adaptive transcoder 230 a desired bit-rate of the stream. Considering both the bandwidth indicated by the client devices 250a . . . 250n and the actual available bandwidth of the network as calculated by the adaptive transcoder 230, the adaptive transcoder 230 transmits a bit stream at an appropriate rate to each client device 250a . . . 250n.

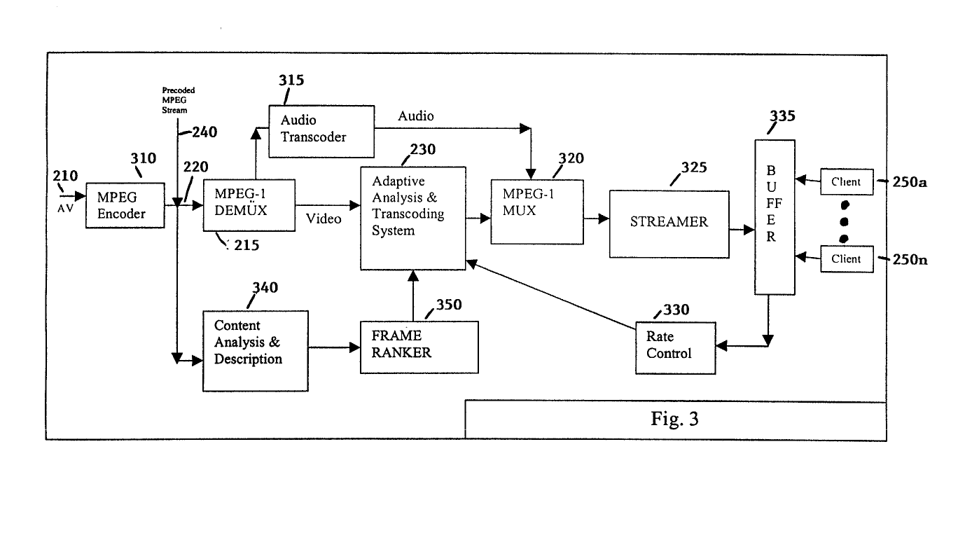

FIG. 3 depicts an illustrative block diagram of a detailed view of an embodiment of this invention. The system of FIG. 3 includes a MPEG encoder 310, a MPEG demultiplexer 215, an audio transcoder 315, a content analysis and description subsystem 340, an adaptive video transcoder 230, a frame ranker subsystem 350, a MPEG multiplexer 320, a data streamer 325, a rate control subsystem 330, a buffer 335. A live incoming audio/video stream 210 is sent to a MPEG encoder 310 or an encoded MPEG stream 220 is sent to a content analysis and description subsystem 340. The MPEG encoder 310 encodes the stream at a highest bit-rate that is expected to be streamed. The encoder then transmits the audio/video stream 210 to MPEG demultiplexer 310 which separates the audio and video data into corresponding audio and video streams, and sends the audio data to an audio transcoder 315 and sends the video data to an adaptive transcoder 230. The audio data is sent to an audio transcoder 315, which converts the audio bit-rate as described above by, for example, changing the sampling frequency or by stereo to mono conversion. The audio transcoder 315 then sends the transcoded audio data to multiplexer 320. The adaptive transcoder 230 creates a bandwidth adaptive video bit stream by replacing I, P, or B frames, as appropriate, with Pseudo-P frames, described further below. The adaptive transcoder 320 then sends each client 250a . . . 250n a specific bit-rate data stream that is consistent with both an amount of available bandwidth on a particular network and at a particular time.

The content analysis and description subsystem 340, which corresponds to a conventional content and analysis description module, determines various features of the stream, including, for example, audio and video activity measures, speaker changes, and a function of a frame, such as, shot boundary frames, key frames, scene change frames, etc. Video activity may be determined, for example, according to a number of motion vectors in each frame. The following table depicts an exemplary output of the content and analysis description subsystem 340. In this table, the feature values included in the third column corresponds to: 0-no feature; 1-shot boundary frame; 2-key frame.

| Time | Frame Number | Feature |
|---|---|---|
| 24099689400 | 1000000 | 1 |
| 24099689539 | 1000001 | 2 |
| 24099689638 | 1000002 | 2 |
| 24099689668 | 1000003 | 2 |
| 24099689694 | 1000004 | 2 |
| 24099689748 | 1000005 | 2 |
| 24099690062 | 1000006 | 2 |
| 24099690465 | 1000007 | 0 |
| 24099690513 | 1000008 | 2 |
| 24099690628 | 1000009 | 2 |
| 24099690744 | 1000010 | 2 |
| 24099690817 | 1000011 | 2 |
| 24099690867 | 1000012 | 2 |
| 24099691104 | 1000013 | 2 |
| 24099691252 | 1000014 | 1 |
| 24099691636 | 1000015 | 0 |

The content analysis and description subsystem 340 sends the analysis information to a frame ranker subsystem 350 which determines an importance of each frame as an integer and assigns the integer to the frame as an indicator of a rank of the frame. The rank of a frame indicates the importance of the frame. For example, frames that correspond to changes in a scene of a video stream are marked as important frames and are assigned higher numerical ranks than other frames. The rank of the frame is computed as a function of the features of the stream in the neighborhood of the frame, i.e., the rank of each frame is determined according to the feature of the frame and is therefore a function of the features of the frame. Thus, each feature is assigned a rank, ranging from 0 to 5, with 0 being the highest rank and 5 being the lowest rank. The frames corresponding to the most important features are assigned the highest rank and the lesser important frames are assigned a lower rank. Thus, for example, whenever the feature is a “shot boundary frame,” the rank is 0 indicating that the frame is important.

To determine an appropriate rank for each frame, the frame ranker subsystem 350 applies a set of rules. The rules may vary according to the type of video data being streamed. Thus, for example, the rules applied when streaming a news video may differ from the rules applied when streaming a video of a sporting event.

In determining a rank for a current frame, the rules consider extracted features of both the current frame and the previous frame that was ranked. Following is an exemplary set of rules that can be used to determine a rank of a previous frame:

(1) Assign a default rank to the frame as follows: if frame is a shot boundary frame, then rank=2, OR if frame is a key frame then rank=3, OTHERWISE rank=4.

(2) If the frame contains text OR if the previous frame was blank OR if the frame contains crowd noise then rank=rank−1.

(3) If the frame contains a graph OR contains a text change OR if the previous frame corresponds to silence then rank=0.

(4) If the previous frame contained text and the frame contains text but no text change then rank=rank+1.

(5) If the features of the previous frame are identical to the features of the frame AND neither the previous frame nor the frame contain text AND the time interval between the frames is less than a threshold time (e.g., 1 second) then rank of previous frame=(rank of previous frame+1).

(6) Covert ranks of frame and previous frame into the range 0 to 5.

(7) Transmit rank of previous frame and mark the current frame as the previous frame.

One of skill in the art will appreciate that the above processing to determine a rank of a frame is performed for each frame included in a stream of video data and that the processing may vary depending on the type of data being streamed.

After assigning a rank to a frame, the frame ranker 350 passes the ranked frames to the adaptive transcoder 230. The adaptive transcoder 230 uses the frame rank to determine which frames should be replaced with “Pseudo-P” frames, described further below. Frames having higher numerical ranks, i.e., more important frames, will not be replaced by Pseudo-P frames.

Once the adaptive transcoder 230 and audio transcoder 315 code their respective data streams, the audio and video streams are transmitted to a MPEG multiplexer 320. The multiplexer 320 combines the two streams (audio and video) and outputs a single stream to a conventional data streamer 325. The streamer transmits the data stream to a client 250a . . . 250n via an output buffer 335. The rate control system 330 monitors the “fullness” of the buffer (as indicated by the amount of data in the buffer at a given time), estimates the bandwidth capability of each client, i.e., the bandwidth available to each client, and instructs the adaptive transcoder 230 to adjust the bit-rate of the stream according to the bandwidth available to a particular client. The data streamer 325 performs many of the client's housekeeping activities including, for example, connection start-up, connection termination, and reconnection when a connection is interrupted.

The rate control subsystem 330 controls the bit-rate at which data is streamed to a particular client 250a . . . 250n. It determines the available bandwidth to the particular client according to the amount of data included in the buffer 335. More specifically, the rate control system 330 determines, i.e., estimates the rate at which data is being streamed to a client 250a . . . 250n, for example, as follows:

At an instant of time “t”, a buffer size can be determined according to the following equation

bₜ=bₜ₋₁+(Rᵢₙ−Rₒᵤₜ)Δt

Where,

Rᵢₙ is the input Rate

Rₒᵤₜ is output Rate

bₜ is Buffer size at time t

bₜ₋₁ is Buffer size at time (t−1)

Δt is time interval between time “t” and time “(t−1)”

According to this equation, we determine an output rate of the buffer as follows:

Rᵢₙ−Rₒᵤₜ=(bₜ−bₜ₋₁)/Δt

Rₒᵤₜ=Rᵢₙ−(bₜ−bₜ₋₁)/Δt

The above equations indicate an amount of data in the buffer at time t, which in turn indicates an estimate of the bandwidth that is available to a particular client. This estimated value is used by the adaptive transcoder 230 to generate a stream to be transmitted to a client at a particular bit-rate.

Consider the following example: Suppose a stream of predictive coded video data is transmitted at a rate of 30 Kbytes per second. A buffer of size 256K is receiving a stream of data at a rate of 12 Kbytes per second and a client is reading from the buffer at a rate of 10 Kbytes per second. According to this invention, Pseudo P-frames are needed to replace a number of frames such that the bit-rate is reduced by at least 2 Kbytes per second so that there is no overflow in the buffer. As described above, the frame rank of the received frames indicates which frames will be replaced. The resulting video display will thus not look as natural as a video in which no frames are being replaced with Pseudo-P frames. The video display may look more like a slide show, which includes some still pictures, than a congruous video. Similarly, if a client device is reading from the buffer at a rate of 24 Kbytes per second, a fewer number of frames need to be replaced with Pseudo-P frames. Thus, the resulting video display is more natural, i.e., closer to a full motion video, than a display resulting from the replacement of frames with Pseudo-P frames.

Further details of how the adaptive transcoder 230 determines which frames to replace with Pseudo-P frames are now provided. An MPEG stream consists of I, P and B type frames. I frames, or “intra” frames, are spatially compressed frames. P frames, or “predicted” frames, are predicted from I frames or other P frames using motion prediction. B frames, or “bi-directional” frames, are interpolated between I and P frames. P frames achieve a bit reduction of approximately fifty percent from their corresponding I frames. B frames achieve bit reduction of approximately seventy-five percent from their corresponding I frames. Actual bit reduction differs according to the content of a picture and the mix of I, P, and B frames in the stream and various other settings for spatial compression. For example, if a stream includes a large number of B frames, then replacing some of the B frames with Pseudo-P frames would greatly reduce the bit-rate of the stream. In the invention, whenever there is reduction in available bandwidth, which is detected and fed back to the invention by the rate controller, the invention retains as many as possible of the most important frames that can be transmitted at the reduced bandwidth, and replaces some of the less important frames with Pseudo-P frames, according to the frame rank that is assigned to each frame in a bit stream by the frame ranker subsystem 350. During frame replacement, since the B-coded frames achieve a greatest bit reduction they are replaced first.

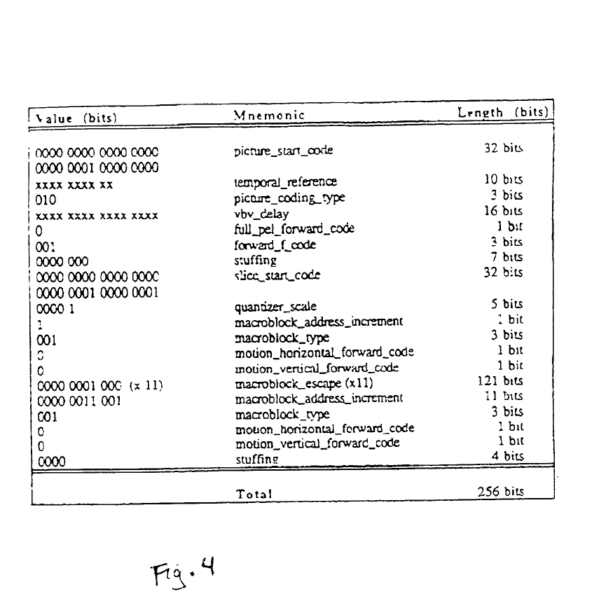

FIG. 4 depicts an illustrative Pseudo-P frame. As depicted in FIG. 4, each Pseudo P-frame is coded with only a few bits. Thus, the impact of a Pseudo P-frame on display of video stream is nearly instantaneous. A Pseudo-P frame replaces a current frame and replicates a previous decoded (and displayed) frame. A Pseudo P-frame thus causes the previous frame to be re-shown. More specifically, during the instant that a Pseudo-P frame replaces a B frame, there is no motion in the video. The Pseudo-P frames use the MPEG coding scheme but essentially contain no video data. Rather, they are data frames that instruct the decoder on the client to continue showing the previous frame for the duration of time that the frame which the Pseudo-P frame replaces was to be shown. If the bandwidth reduces further, a Pseudo-P-frame also replaces the P frame. In the case of very low bandwidth, a Pseudo-P frame may also replace an I frame. This method of frame replacement allows replacement of either only a B frame with a Pseudo-P frame or allows bit-rate reduction by replacing a P frame and a B frame, which depends on the P frame from which the B frame was interpolated, with Pseudo-P frame. However, because replacing only the P frames of a stream with Pseudo-P frames affects each of the B frames that depend on those P-frames, Pseudo-P frames cannot be used to replace only P-frames. Rather, if a P-frame is replaced with a Pseudo P-frame, the B frame which depends from the P-frame is also replaced with a Pseudo P-frame. Thus, the less bandwidth that a client has available, the slower the resulting video display, creating a slideshow effect. When a client has greater bandwidth capabilities, the resulting video display is closer to that of a full motion video. Therefore, this invention allows the resulting bit stream to be scaled from full motion video to a slide show kind of bit stream.

As depicted in FIG. 4, each Pseudo P-frame includes 256 bits. By replacing an I, P, or B frame with a Pseudo P-frame, the 256 bits of the Pseudo P-frame cause the previous frame to be redisplayed, generating a repeat display of a specific picture.

The frame ranker subsystem determines which of the I, P, or B frames should be replaced with Pseudo P-frames. As described above, the frame ranker subsystem 350 determines the importance of each frame and represents it as a numerical rank. This frame rank is used by the adaptive transcoder 230 to determine which frames should be replaced with Pseudo-P Frames. For example, a frame representing a scene change is more important than a key frame in a shot and is thus assigned a higher frame lank. Therefore, if the bandwidth available to a particular client is low, same of key frames may be replaced with Pseudo-P frames but all of the scene change frames are retained. Now if a client has a slightly higher available bandwidth both the scene change frames and the key frames may be retained while the other frames are replaced with Pseudo-P frames. Similarly if the frame ranker 350 assigns frames carrying text or a graph a higher rank than other types of frames, when the bandwidth falls low, the graph and text frames will be retained and other frames may be replaced by Pseudo-P frames. Such rules are applied to the features extracted by the content analysis and description system, and combinations of these features to determine which frames to retain and which to replace.

One of ordinary skill in the art will appreciate that the above description is exemplary only and that this invention may be practiced with additional or different components and is limited only by the appended claims and the full scope of their equivalents.

What is claimed is:

1. A method for transmitting predictive coded video data to a client, comprising:
receiving a video data stream including predictive coded video data;
analyzing the video data stream to determine characteristics of the stream;
determining an available bandwidth for transmission of the video data stream to a particular client;
determining, according to the characteristics of the video data stream and the available network bandwidth, a coded frame of the video data stream that can be replaced with a replicating frame that replicates a previously decoded frame;
replacing the coded frame with the replicating frame to produce a modified video data stream; and
transmitting the modified video data stream to the client.

2. The method of claim 1, wherein the analyzing includes determining information that relates to an importance of a frame included in the video data stream.

3. The method of claim 1, wherein the determining an available bandwidth includes determining a rate at which data is being streamed to the client.

4. A method for transmitting an audio/video data stream to a client, comprising:
receiving an audio/video data stream;
analyzing the audio/video data stream to determine characteristics of the stream;
separating the audio/video data into an audio data stream and a video data stream;
determining an available bandwidth for transmission of the video data stream to a particular client;
determining, according to the characteristics of the video data stream and the available network bandwidth, a coded frame of the stream that can be replaced with a replicating frame that replicates a previously decoded frame;
replacing the coded frame with the replicating frame to produce a modified video data stream; and
transmitting the modified video data stream and the audio data stream to the client.

5. The method of claim 4, further comprising reducing a bit-rate of the audio data stream to produce a modified audio data stream and transmitting the modified audio data stream to the client.

6. A method for adaptive transcoding of video data, comprising:
receiving a stream of video data;
determining in real-time an available bandwidth for transmission to a client; and
creating a modified stream of video data by replacing a frame with an encoded frame that replicates a previous decoded frame.

7. The method of claim 6, further including receiving a stream of audio data that is associated with the stream of video data.

8. The method of claim 6, wherein the determining includes determining a network capability of the client.

9. The method of claim 6, further including receiving a stream of MPEG-1 video data.

10. The method of claim 6, further including receiving a stream of MPEG-2 video data.

11. The method of claim 6, further including receiving a live stream of audio and video data.

12. The method of claim 6, further including receiving a precoded stream of video data.

13. The method of claim 6, wherein determining the available bandwidth includes determining a rate at which data is being streamed to the client.

14. A system to transcode predictive coded video data, comprising:
a client that receives a modified stream of video data;
a content analysis and description system that analyzes the stream of video data to determine characteristics of the stream;
a frame ranker subsystem that assigns a numerical rank to each frame included in the stream of video data;
a rate control subsystem that determines an available bandwidth of a network and of the client for transmission of the stream of video data to the client; and
a transcoder subsystem that modifies a received stream of predictive coded video data to accord with the available bandwidth by replacing a frame with a previous encoded frame that replicates a previous decoded frame according to a frame rank.

15. The system of claim 14, further including an audio transcoder subsystem that receives an audio stream of data that is related to the stream of video data and encodes the audio stream of data to reduce the bit-rate of the stream.

16. The system of claim 15, further including a multiplexer that combines the modified audio portion and the modified video data into a single stream.

17. The system of claim 14, further including a streamer that transmits the stream of modified data to the client.

18. The system of claim 14, further including an audio transcoder subsystem that modifies an audio portion of a stream of data and sends the modified audio portion of the stream to the transcoder.

19. The system of claim 14, further including a demultiplexer that receives a stream of audio and video data and separates the stream into an audio stream and a video stream.

20. The system of claim 14, further including a buffer to hold the stream of modified audio and video data prior to transmission to the client.

21. The system of claim 14, wherein the rate control subsystem considers an amount of data included in a buffer that transmits data to the client when determining an available bandwidth.

22. A method for transmitting predictive coded video data that includes a sequence of frames, comprising:
receiving a stream of video data;
analyzing the stream to determine characteristics of the stream;
determining an available bandwidth for transmission of the stream;
coding the video data by determining, according to the characteristics of the stream and the available network bandwidth for a client, a predictive coded frame that can be replaced with a replicating frame that replicates the previous decoded frame and replacing the predictive coded frame with the replicating frame to produce a modified stream; and
transmitting the modified stream to the client.

23. A computer-readable medium including instructions for transmitting predictive code video data, the instructions comprising:
receiving a stream of video data;
determining in real-time an available bandwidth for transmission to a client; and
creating a modified stream of video data by replacing a frame with an encoded frame that replicates a previous decoded frame.
